(19) United States
(12) Patent Application Publication
(10) Pub. No.: US 2007/0183002 A1
(43) Pub. Date: Aug. 9, 2007

(54) System and method for user selectable scan settings on a scan capable device

(76) Inventor: Fatima Corona, Long Beach, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/349,320

(22) Filed: Feb. 7, 2006

(51) Int. Cl. H04N 1/04

(52) U.S. Cl. 358/474; 358/1.13

(57) ABSTRACT

A system and method for saving and retrieving scan settings at a device with scan capability for each of a plurality of users are disclosed. In one aspect, the method of saving scan settings comprises receiving a plurality of sets of scan settings from a plurality of users, each set associated with a particular user, and saving each set of received scan settings at the device. In another aspect, the method of retrieving previously saved scan settings comprises retrieving and displaying a list of identifiers each associated with a set of settings saved in association with each user and retrieving a set of settings associated with the identifier selected by the user from the list. In another aspect, the system for saving and retrieving scan settings comprises an input interface for receiving data from a user, a display for providing information to the user, a storage device for saving user data comprising sets of scan settings and user account information, and a processor executing software applications to control the input interface and the display to realize user interaction and to save and retrieve data to and from the storage device.

### BACKGROUND OF THE INVENTION

1. Field of the Invention

The invention relates to the operation of a device with scan capability. More particularly, the invention relates to saving and retrieving scan settings at a scan capable device on a user by user basis.

2. Description of the Related Technology

A scan capable device may be shared by multiple users. Current technology allows only the system administrator to save scan settings on the device. A user can only choose one of the settings pre-created by the administrator. In order to increase work efficiency, there is a need to allow individual users to modify, save, and retrieve settings customized for their own needs on the device.

### SUMMARY OF CERTAIN INVENTIVE ASPSECTS

The system, method, and devices of the invention each have several aspects, no single one of which is solely responsible for its desirable attributes. Without limiting the scope of this invention, its more prominent features will now be discussed briefly.

In one aspect, a method of saving scan settings at a device with scan capability for a plurality of users comprises receiving a plurality of sets of scan settings from a plurality of users, each set associated with a particular user, and saving each set of received scan settings at the device.

In another aspect, a method of saving scan settings at a device with scan capability for each of a plurality of users comprises logging on each user to a user account with authentication data received from the user, receiving a set of scan settings from the user, and saving the set of received scan settings at the device.

In another aspect, a method of retrieving previously saved scan settings at a device with scan capability for each of a plurality of users comprises retrieving and displaying a list of identifiers each associated with a set of settings saved in association with each user and retrieving a set of settings associated with the identifier selected by the user from the list.

In another aspect, a system for saving and retrieving scan settings for a plurality of users at a device with scan capability comprises an input interface for receiving data from a user, a display for providing information to the user, a storage device for saving user data comprising sets of scan settings and user account information, and a processor executing software applications to control the input interface and the display to realize user interaction and to save and retrieve data to and from the storage device.

In another aspect, a system for saving scan settings at a device with scan capability for each of a plurality of users comprises means for logging on each user to a user account with authentication data received from the user, means for receiving a set of scan settings from the user, and means for saving the set of received scan settings at the device.

In another aspect, a system for retrieving previously saved scan settings at a device with scan capability for each of a plurality of users comprises means for logging on each user to a user account with authentication data received from the user, means for retrieving and displaying a list of identifiers each associated with a set of settings saved in association with the user account, and means for retrieving a set of settings associated with the identifier selected by the user from the list.

### BRIEF DESCRIPTION OF THE DRAWINGS

FIG. 1 is a block diagram illustrating one embodiment of a system in which a scanning device is connected to multiple computers.

FIG. 2 is a block diagram illustrating one embodiment of a system for saving scanning settings for multiple users on the scanning device as illustrated in FIG. 1.

FIG. 3 is a flowchart of one embodiment of a method for saving and retrieving scan settings on the scanning device as illustrated in FIG. 1.

FIG. 4 is a flowchart illustrating one embodiment of the process to request authentication data shown in FIG. 3.

FIG. 5 is a flowchart illustrating one embodiment of the process to receive a group of settings shown in FIG. 3.

FIG. 6 is a flowchart illustrating one embodiment of the process to save the group of settings shown in FIG. 3.

### DETAILED DESCRIPTION OF CERTAIN INVENTIVE EMBODIMENTS

Various aspects and features of the invention will become more fully apparent from the following description and appended claims taken in conjunction with the foregoing drawings. In the drawings, like reference numerals indicate identical or functionally similar elements.

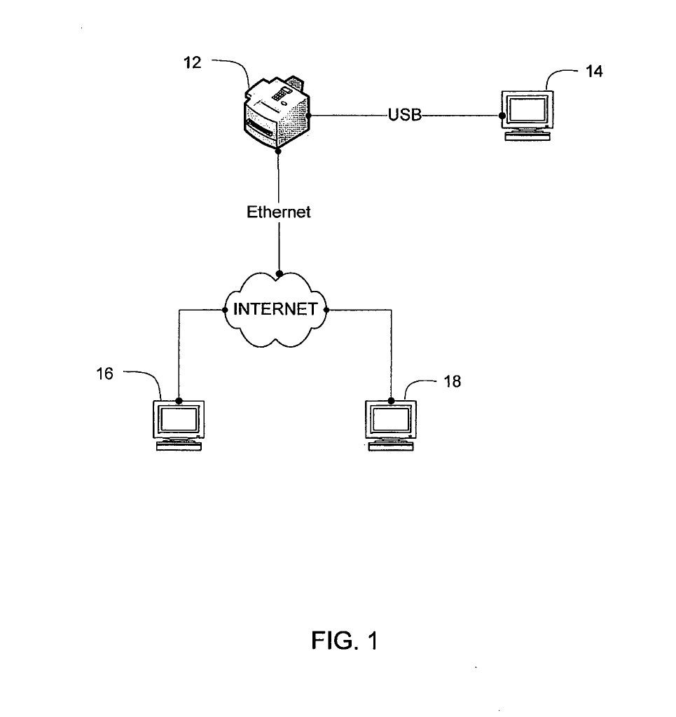

FIG. 1 is a block diagram illustrating one embodiment of a system in which a scanning device is connected to multiple computers. The scanning device 12 can be any suitable device having a scanning capability. Some examples are a multi-function peripheral (MFP) device, a scanner device, a fax machine, and an “All-In-One” device. In some applications, the scanning device 12 needs to be connected to one or more computers for various purposes. In one embodiment, the scanning device 12 is connected to a computer 14 via a wired connection such as a USB cable as shown in FIG. 1. In another embodiment, the scanning device 12 is connected to a computer via a wireless connection (not illustrated). In still another embodiment, the scanning device 12 is connected to a network, wired or wireless, to which multiple computers are connected. The network may be a local area network (LAN), wide area network (WAN), or the Internet, for example. In FIG. 1, the scanning device 12 is connected to the Internet via an Ethernet connection. Two computers 16 and 18 are also connected to the Internet. In this way, the scanning device 12 can send any scanned documents to computers 16 and 18 via the Internet.

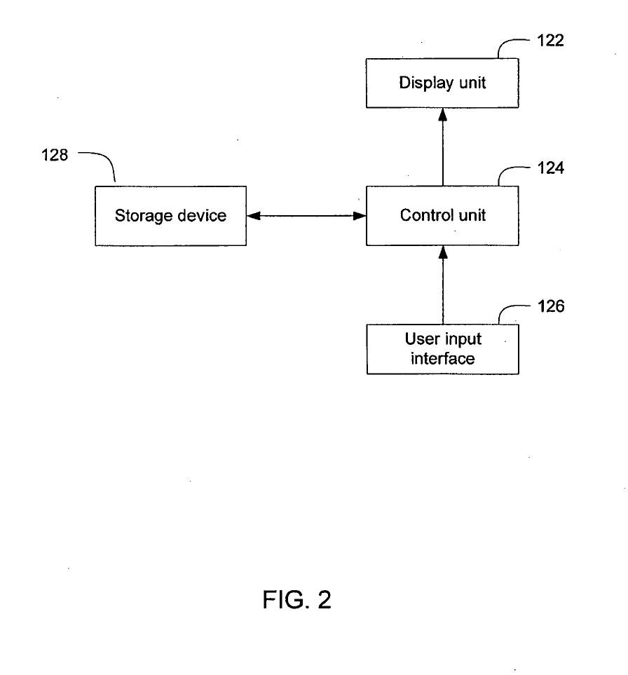

FIG. 2 is a block diagram illustrating one embodiment of a system for saving scanning settings for multiple users on the scanning device as illustrated in FIG. 1. The system comprises a display unit 122, a control unit 124, a user input interface 126, and a storage device 128.

The user input interface 126 and the display unit 122 are included to enable user interaction. The display unit 122 is used to communicate information, instructions, or data to a user. The user input interface 126 is configured to receive input data from a user.

Both the display unit 122 and the user input interface 126 can be implemented in many forms and may contain multiple components. In one embodiment, the display unit 122 may be, for example, a LCD. The user input interface 126 may include a keypad or keyboard. In other embodiments, the user input interface 126 and the display unit 122 may be integrated together in one device such as a touch screen as incorporated in a panel of certain copy machines.

Both the display unit 122 and the user input interface 126 can be an integral part of, or an external device connected to, the scanning device 12. In certain embodiments, both the display unit 122 and the user input interface 126 are connected to a computer which is connected to the scanning device 12 through a communication link. The scanning device 12 interacts with the user through the computer.

In the exemplary embodiment, the scanning device 12 also includes a storage device 128 to store data, for example, the scan settings to be saved and a software application which the control unit 124 runs to control the operation. The storage device 128 can be an integral part of, or an external device connected to, the scanning device 12. In certain embodiments, the storage device 128 is configured to keep the data or its contents regardless if the power is turned off or if the storage device is moved to another computer. In one embodiment, the storage device 128 is an internal hard drive. In another embodiment, the storage device 128 can be any kind of flash storing media, for example, a compact flash card.

The control unit 124 controls the operation of the scanning device 12. In one embodiment, the control unit 124 is a processor which may be any suitable general purpose single- or multi-chip microprocessor, or any suitable special purpose microprocessor such as a digital signal processor, microcontroller, or a programmable gate array. As is conventional, the processor may be configured to execute one or more software applications. In certain embodiments, the control unit 124 runs a software application in communication with the display unit 122, the user input interface 126, and the storage device 128, thereby interacting with a user and saving scan settings or retrieving saved settings for multiple users.

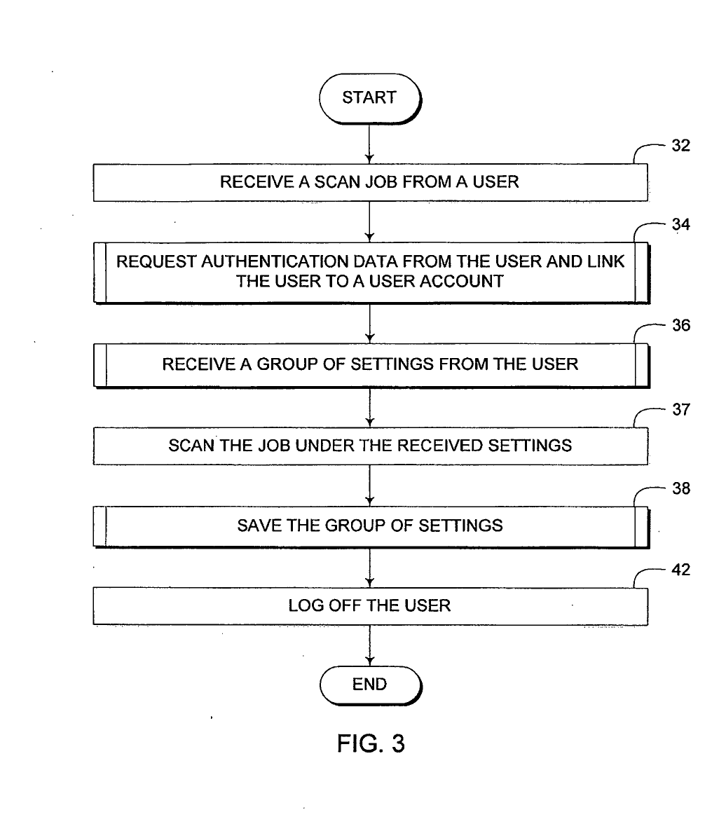

FIG. 3 is a flowchart of one embodiment of a method for saving and retrieving scan settings on the scanning device as illustrated in FIG. 1. The scan settings available for a user to save and retrieve can include any settings related to scanning, depending on what is supported at the device 12. In one embodiment, the scan settings may include, but are not limited to, one or more of the following: destination, document name, metadata, autoexposure, color mode, compression quality, contrast, darkness, sharpness, resolution, document image mode, input edge erase, input media size, image orientation, output image size, magnification, sides to scan, document format.

At a block 32, the scanning device 12 receives a scan job from a user. Typically, that is when the user places a job on the scanning device. Next at a block 34, the device requests authentication data from the user and links the user to the user account. Then at a block 36, the scanning device 12 receives a group of scan settings from the user. Moving to a block 37, the scanning device 12 scans the job under the received settings. At a block 38, the scanning device 12 saves the group of settings on the scanning device 12. Moving to a block 42, the device logs the user off. Blocks 32, 34, and 36 will be described in detail with reference to additional flowcharts.

It will be appreciated that the blocks 32 and 37 are optional. In certain embodiments, the scanning device 12 receives settings without necessarily receiving a scanning job. For example, a user may come to the scanning device 12 to customize and save a set of settings for future scan jobs. It will also be appreciated that the blocks 34 and 42 are optional. In certain embodiments, the scanning device 12 does not require each user to have a user account. In that case, the user can save the settings associated to a unique name wherein the saved settings can be accessed by any user.

It will be appreciated that in order to change or save settings for a scan job, the user does not necessarily need to go to the scanning device 12. In certain embodiments, the user can change and save the settings at a remote location through a communication link to the scanning device 12. In one embodiment, the scanning device 122 is connected to the Internet as illustrated in FIG. 1. The user changes and saves the settings using a remote management web tool which can be invoked by typing the scanning device's IP address or hostname on a web browser such as Internet Explorer. Examples of the remote management web tool include Samsung's Web Sync Thru or like any internal embedded web server of a scanning device.

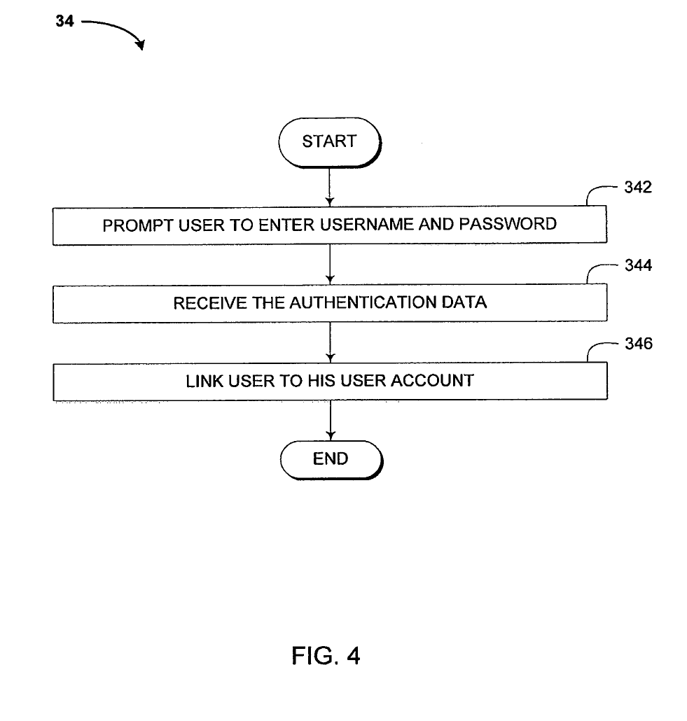

FIG. 4 is a flowchart illustrating one embodiment of the process to request authentication data shown in FIG. 3. As noted above, this process and the block 42 are optional and may be omitted in some embodiments. At a block 342, the scanning device 12 prompts a user to enter his authentication data. The control unit 124 may contain a software application, which sends information to the display unit 122, prompting the user to enter authentication data. Next at a block 344, the control unit 124 receives the authentication data by communicating to the user interface 126 to which the user enters the authentication data.

In certain embodiments, the authentication data is an identification code or number, for example, a username which conforms to a variation of a person's name. Additional information about the user such as a password or a PIN number may also be requested. As discussed above, the user input interface 126 can be implemented in different ways and may contain multiple components. In one embodiment, the user input interface 126 is a keypad and the authentication data such as username and password can be entered using the keypad. In another embodiment, the user input interface 126 may include a special device which retrieves user authentication data by scanning a user identification card or biometric information and sends the data to the control unit 124.

Moving to a block 346, the scanning device 12 links the user to a user account using the received authentication data. The control unit 124 may contain a software application, which manages and maintains user profiles saved on the storage device 128. As discussed above, the storage device 128 may be integrated within the scanning device 12 or attached to the scanning device 12 remotely. In either case, the control unit 124 is in data communication with the storage device 128. By reading the data saved on the storage device 128, the control unit 124 is able to link the current user to his user account.

The user profile can be organized in different formats. In one embodiment, the control unit 124 manages and maintains a database to save user data. In another embodiment, the user data may be managed by a file directory system.

It will be appreciated that a valid user account should have been established for the current user prior to this operation. In certain embodiments, the operation to establish a user account can be performed only by the system administrator in a separate process not described here.

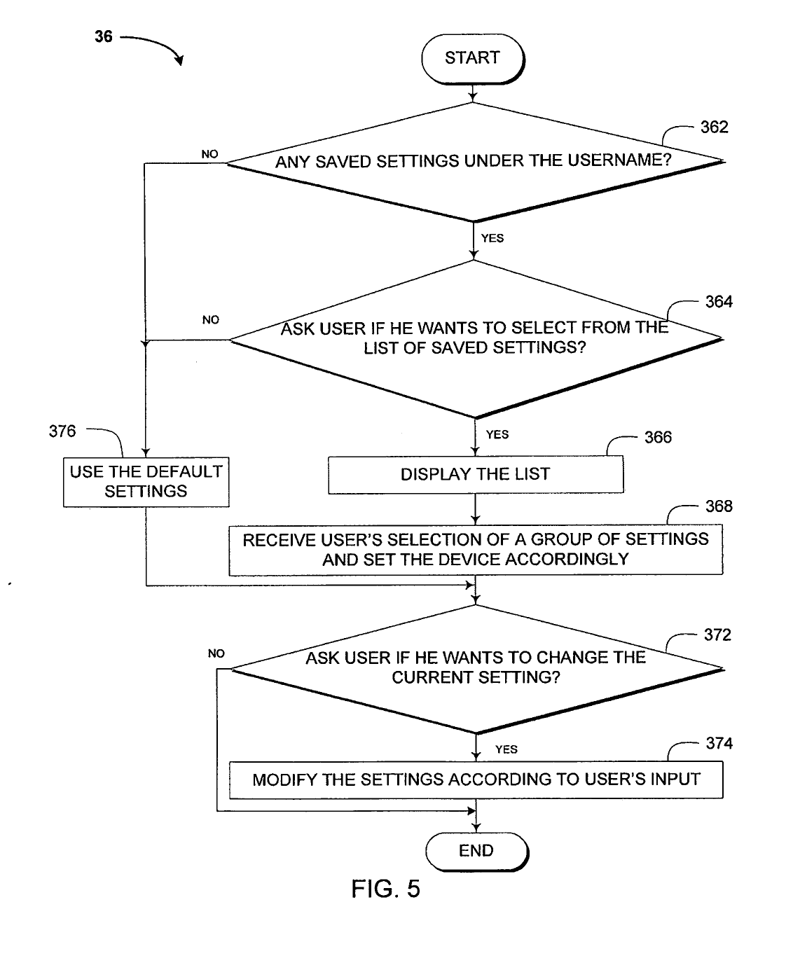

FIG. 5 is a flowchart illustrating one embodiment of the process to receive a group of settings shown in FIG. 3. In the block 36, the scanning device 12 receives a group of settings from the user in this process. The user can either choose a default setting, or retrieve a set of settings saved earlier, and then make any necessary changes to the selected settings. In the exemplary embodiment, the control unit 124 runs a software application which manages the whole process.

At a block 362, the control unit 124 checks whether there are any saved settings under the user account by checking the user data saved on the storage device 128. In one embodiment, each user has a unique username and the inquiry can be made under the current username. If there are saved settings under the user account, the process moves to a block 364, where the control unit 124 sends information to the display unit 122, asking the user whether he wants to select one of previously saved settings. If the user indicates yes, the process moves to a block 366. At this block, the control unit 124 retrieves a list of names representing each group of saved scan settings from the storage device 128 and sends the list to the display unit 122 to be displayed to the user. Next at a block 368, the control unit 124 receives the user's choice of one of names as displayed in a list. The control unit 124 then retrieves the group of settings associated to the name as chosen from the storage device 128 and sets the scanning device 12 to the selected settings.

If the control unit 124 decides that there are no saved settings under the user account at the block 362, or if the user indicates that he does not want to choose one of the groups of saved settings at the block 364, the process moves to a block 376. At this block, the control unit 124 has decided that no saved settings will be used. Therefore, the control unit 124 loads a pre-set default group of settings into the scanning device 12.

The process moves next to block 372 from either the block 368 or block 376 after a group of settings is loaded into the scanning device 12. At the block 372, the control unit 124 sends information to the display unit 122, asking whether the user wants to make further changes to the current settings as selected. The process then moves to a block 374 if the user wants to make further changes. At the block 374, the control unit 124 modifies the settings according to user's input from the user input interface 126. The process will end after the block 372 if the user does not want to make any changes.

In certain embodiments, users can save and modify groups of scan setting without logging in. In that case, at the block 362, the control unit 124 checks whether there are any saved settings, instead of checking it under a particular user account.

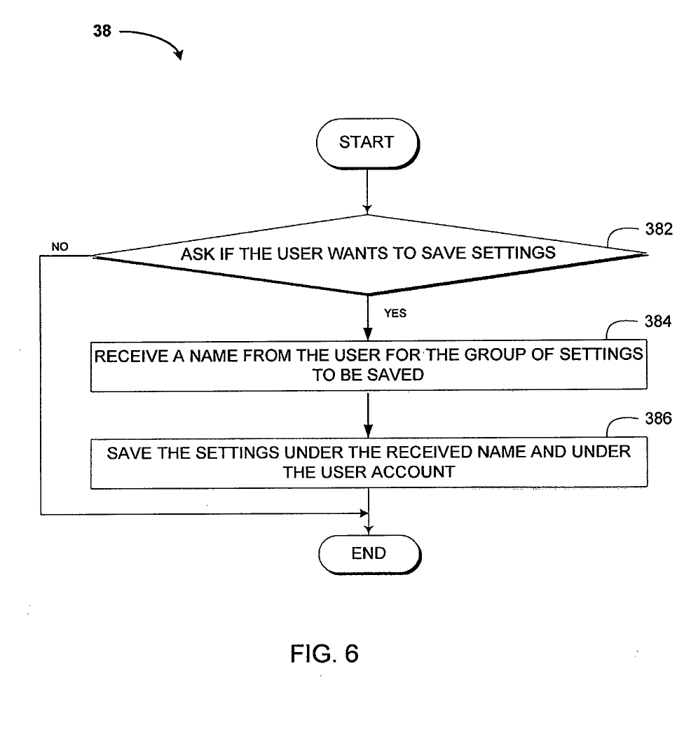

FIG. 6 is a flowchart illustrating one embodiment of the process to save the group of settings shown in FIG. 3. In previous Blocks as illustrated in FIG. 3, the control unit 124 receives a group of scan settings from the user. The exemplary process in FIG. 6 saves the group of setting received on the scanning device 12.

At a block 382, the control unit 124 sends information to the display unit asking if the user wants to save current settings. The process will end if the user chooses not to save settings. Otherwise, the process moves to the next b. At a block 384, the control unit 124 receives a name, for example, My_Photo_Scanning_Settings, from the user through the user input interface 126 to identify the group of settings to be saved. Next at a block 386, the control unit 124 saves the group of settings to the storage device 128, associating the group of settings to the received name. In certain embodiments in which the user has logged in to a user account, the group of settings saved may be further associated to the current user account. In other words, the saved group of settings is to be identified by a combination of the name and the user account. A database may be used to implement the association between the saved settings and the receive name, but other ways are also easily available, such as a file directory system.

The foregoing description details certain embodiments of the invention. It will be appreciated, however, that no matter how detailed the foregoing appears in text, the invention can be practiced in many ways. It should be noted that the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A method of saving scan settings at a device with scan capability for a plurality of users, comprising:
receiving a plurality of sets of scan settings from a plurality of users, each set associated with a particular user; and
saving each set of received scan settings at the device.

2. The method of claim 1, wherein the settings saving further comprises:
receiving an identifier to identify the set of scan settings to be saved from the user; and
associating and storing the set of received scan settings and the received identifier.

3. The method of claim 1, wherein the settings saving saves the scan settings in a storage device configured to store data even when the storage device does not receive power.

4. The method of claim 3, wherein the storage device may be integrated in or external to the device with scan capability.

5. The method of claim 1, wherein the scan settings are received through a communication link.

6. The method of claim 1, wherein the set of scan settings include at least one of the following: destination, document name, metadata, autoexposure, color mode, compression quality, contrast, darkness, sharpness, resolution, document image mode, input edge erase, input media size, image orientation, output image size, magnification, sides to scan, document format.

7. The method of claim 1, wherein multiple sets of scan settings may be saved for each user.

8. A method of saving scan settings at a device with scan capability for each of a plurality of users, comprising:
logging on each user to a user account with authentication data received from the user;
receiving a set of scan settings from the user; and
saving the set of received scan settings at the device.

9. The method of claim 8, wherein the settings saving further comprises:
receiving an identifier to identify the set of scan settings to be saved from the user; and
associating and storing the set of received scan settings and the received identifier in association with the user account.

10. The method of claim 8, wherein the settings receiving and the identifier receiving are through a communication link.

11. The method of claim 10, wherein the communication link is a network connection established when the user types in the device's IP address or hostname on a web browser.

12. The method of claim 8, wherein the settings saving saves the settings in a storage device configured to store data even when the storage device does not receive power.

13. The method of claim 12, wherein the storage device may be integrated in or external to the device with scan capability.

14. The method of claim 8, further comprising logging off the user.

15. The method of claim 8, wherein the set of scan settings include at least one of the following: destination, document name, metadata, autoexposure, color mode, compression quality, contrast, darkness, sharpness, resolution, document image mode, input edge erase, input media size, image orientation, output image size, magnification, sides to scan, document format.

16. The method of claim 8, wherein multiple sets of scan settings may be saved for each user.

17. A method of retrieving previously saved scan settings at a device with scan capability for each of a plurality of users, comprising:
retrieving and displaying a list of identifiers each associated with a set of settings saved in association with each user; and
retrieving a set of settings associated with the identifier selected by the user from the list.

18. A system for saving and retrieving scan settings for a plurality of users at a device with scan capability, comprising:
an input interface for receiving data from a user;
a display for providing information to the user;
a storage device for saving user data comprising sets of scan settings and user account information; and
a processor executing software applications to control the input interface and the display to realize user interaction and to save and retrieve data to and from the storage device.

19. The system of claim 18, wherein the storage device is configured to store data even when the storage device does not receive power.

20. The system of claim 18, wherein the display and the input interface are integrated in a single device.

21. The system of claim 18, wherein the processor is connected to the input interface and the display through a communication link.

22. The system of claim 18, wherein the processor is connected to the storage device through a communication link.

23. A system for saving scan settings at a device with scan capability for each of a plurality of users, comprising:
means for logging on each user to a user account with authentication data received from the user;
means for receiving a set of scan settings from the user; and
means for saving the set of received scan settings at the device.

24. The system of claim 23, wherein means for saving further comprises:
means for receiving an identifier to identify the set of scan settings to be saved from the user; and
means for associating and storing the set of received scan settings and the received identifier in association with the user account.

25. A system for retrieving previously saved scan settings at a device with scan capability for each of a plurality of users, comprising
means for logging on each user to a user account with authentication data received from the user;
means for retrieving and displaying a list of identifiers each associated with a set of settings saved in association with the user account; and
means for retrieving a set of settings associated with the identifier selected by the user from the list.
